(19) United States
(12) Patent Application Publication
(10) Pub. No.: US 2006/0103789 A1
(43) Pub. Date: May 18, 2006

(54) Liquid crystal display panel and liquid crystal display device

(75) Inventors: Sounosuke Takahashi, Kanagawa (JP); Yoshikazu Sakaguchi, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KANAGAWA (JP)

(21) Appl. No.: 11/274,324

(22) Filed: Nov. 16, 2005

(30) Foreign Application Priority Data
Nov. 16, 2004 (JP) 2004-331752

(51) Int. Cl. G02F 1/1333; G02F 1/1343

(52) U.S. Cl. 349/110; 349/141

(57) ABSTRACT

In a display panel of an active matrix-type liquid crystal display device in an In-Plane Switching mode, a black matrix is formed on the surface of a transparent substrate of a color-filter substrate, the surface being at a side opposed to a TFT substrate. The black matrix is made of a laminated film for which a metal oxide film and a metal film have been alternately laminated in two layers or more. The black matrix has a thickness of 0.2 μm or less and an OD value of 3 or more. Moreover, an electric-field shielding layer made of an ITO film connected to a common electrode is provided on a data line formed on the TFT substrate, via an insulating film. Furthermore, an impurity is doped in a liquid crystal layer so that resistance thereof becomes 1×10¹¹ through 1×10¹³Ω·cm.

### BACKGROUND OF THE INVENTION

1. Technical Field of the Invention

The present invention relates to an active matrix-type liquid crystal display panel in an In-Plane Switching mode for carrying out a display by controlling the array direction of liquid crystal particles by a horizontal electric field parallel to the surface of a substrate and a liquid crystal display device comprising the same, and in particular, a liquid crystal display panel and a liquid crystal display device for which a cell gap has been held by columnar spacers.

2. Description of the Related Art

A liquid crystal display device comprises a light source and a liquid crystal panel, and the liquid crystal panel comprises two transparent substrates and a liquid crystal layer filled between these transparent substrates. And, an image is displayed by irradiating light onto the liquid crystal panel from the light source while applying a voltage to the liquid crystal layer of the liquid crystal panel for controlling light transmittance. Therefore, on one of the transparent substrates of the liquid crystal panel, provided is, for example, a pixel circuit for which a plurality of TFTs (Thin Film Transistors) have been arrayed in a matrix form and which applies a voltage to the liquid crystal layer, and on the other transparent substrate, provided is a color filter. Hereinafter, the substrate provided with a pixel circuit will be referred to as a TFT substrate, and the substrate provided with a color filter will be referred to as a color-filter substrate.

An active matrix-type liquid crystal display device for which a pixel circuit on one of the substrates as such has display modes including a TN (Twisted Nematic) mode and an IPS (In-Plane Switching) mode. The IPS mode is a mode for a display by controlling the array direction of liquid crystal particles by a horizontal electric field parallel to the surface of a substrate, and is characterized by a considerably wide angle of view. Therefore, recently, application of IPS-mode liquid crystal display devices to monitors for personal computers and liquid crystal televisions and the like has been rapidly expanding.

FIG. 1 is a sectional view of a display panel of a conventional IPS-mode liquid crystal display device in a direction orthogonal to a direction in which a data line extends, including a spacer. As shown in FIG. 1, for a display panel 101 of the conventional IPS-mode liquid crystal display device, a color-filter substrate 102 and a TFT substrate 103 have been formed parallel to each other, and a liquid crystal layer 104 has been filled therebetween.

In the color-filter substrate 102, a glass substrate 105 has been provided, and on the surface, of the glass substrate 105, at a side opposed to the TFT substrate 103, a black matrix 106 has been provided, whose thickness is on the order of 1.3 μm, for example. This black matrix 106 is generally, in order not to exert influence on an applied electric field, formed of a high-resistance resin material in which a pigment such as carbon black has been dispersed (see Japanese Published Unexamined Patent Application No. 2000-19527, Japanese Published Examined Patent Application No. 3200552, and Japanese Unexamined Published Patent Application No. H10-170958, for example).

In addition, at positions sandwiching the black matrix 106 on the surface of the glass substrate 105, color layers 107a and 107b composing a color filter have been provided, respectively. This color layer 107a is, for example, red (R), and the color layer 107b is, for example, green (G). The color layers 107a and 107b have a thickness of, for example, 1.9 μm, and end portions of the same have been formed so as to run onto end portions of the black matrix 106. Then, in a manner covering the black matrix 106 and color layers 107a and 107b, an overcoat layer 108 having a thickness of, for example, 1.0 μm has been formed. This overcoat layer 108 has risen in a reflection of the shape of the black matrix, and on the surface of the same, a step 113 having a height α of 0.6 μm has been formed.

Furthermore, on the overcoat layer 108 formed above the black matrix 106, a columnar spacer 109 for forming a cell gap d has been formed. This columnar spacer 109 has a height β of, for example, 2.4 μm, and a height obtained by adding the height α of the step 113 formed on the surface of the overcoat layer 108 and height β of the columnar spacer 109, that is, a column height h is, for example, 3.0 μm.

On the other hand, in the TFT substrate 103, a glass substrate 110 has been provided, and on the surface, of this glass substrate 110, at a side opposed to the color-filter substrate 102, a data line 111 and a scanning line (unillustrated) extending in mutually orthogonal directions have been provided, and in the vicinity of a position where this data line 111 intersects with the scanning line, a TFT has been formed. In a region between adjacent data lines 111 on the glass substrate 110, a counter electrode 114 and a pixel electrode 115 are formed so that both become mutually parallel to the data line 111. Furthermore, a passivation film 112 has been provided so as to cover these, and this passivation film 112 has risen in a reflection of the shapes of the respective wirings. And, the columnar spacer 109 has been arranged directly below the data line 111.

However, the prior art as mentioned above has the following problems. As in the conventional liquid crystal display device comprising a display panel shown in FIG. 1, when the black matrix 106 is formed of a resin containing a pigment, in order to obtain a sufficient light-shielding effect, the black matrix 106 must have a thickness on the order of 1.0 through 2.0 μm. Accordingly, the surfaces of the color layers 107a and 107b formed on the black matrix 106 rise by a height equal to a thickness of the black matrix 106, and this rise results in a step 113 having a height α of 0.3 through 1.0 μm on the surface of the overcoat layer 108. If there is such a step on the surface of the overcoat layer 108, this may cause an obstruction in an alignment treatment when forming an alignment film thereon, and an uneven display owing to a disordered alignment of the liquid crystal layer 104 occurs, wherein a problem exists.

In addition, when the cell gap d has been determined in advance, if the step 113 exists on the surface of the overcoat layer 108, the height β of the columnar spacer 109 must be lowered by a height equal to the height α of this step 113, therefore, resilience, that is, the elastic deformation volume of the columnar spacer 109 to pressurization or the like is reduced. Consequently, an unevenness in the gap easily occurs owing to a local pressurization, and there is also a problem in deterioration in display uniformity. This problem similarly occurs not only in a case where columnar spacers are provided, but also in a case where fixing-type granular spacers are provided, and this is particularly remarkable in a liquid crystal display device for which the cell gap d has been narrowed to a gap on the order of 2 to 3 μm.

Furthermore, for filling the liquid crystal layer 104 in the liquid crystal panel 101, a seal pattern is provided in a section from a frame outside the display region to an end portion of the glass substrate, however, when this seal pattern is arranged on the black matrix 106 formed of a pigment-containing resin which is low in adhesion to the glass substrate 105, the black matrix 106 can peel off the glass substrate 105 depending on the conditions. Therefore, in the conventional liquid crystal display device, the seal pattern and black matrix have been designed so as to avoid overlapping, whereby it is difficult to narrow the frame, and the degree of freedom in designing a seal pattern is low, wherein a problem exists.

Still furthermore, the black matrix 106 formed of a pigment-containing resin is low in heat resistance, and for forming an alignment film on the overcoat layer 108, baking is carried out on the order of 220 through 240° C., however, when such a high-temperature treatment step is carried out, the black matrix 106 is changed in quality to fluctuate resistance, wherein a problem exists. In an IPS-mode liquid crystal display device, when resistance of the black matrix becomes 1×10⁶ through 1×10 ¹⁰Ω·cm, an uneven display owing to a non-uniform charging of the black matrix pattern easily occurs. Therefore, with the black matrix 106 formed of a pigment-containing resin whose resistance easily fluctuates, an uneven display easily occurs.

Still furthermore, in the conventional liquid crystal display device, the black matrix 106 has been formed by coating and developing a photosensitive resin in which a pigment such as carbon black has been dispersed, however, adjustment of exposure sensitivity is difficult because of the pigment contained in the resin, and patterning accuracy is low, wherein a problem exists. Therefore, it is difficult to provide the black matrix pattern with a higher definition.

### SUMMARY OF THE INVENTION

It is an object of the present invention to reduce a step caused by a black matrix formed on the surface of an overcoat layer and provide a liquid crystal display panel and a liquid crystal display device excellent in display quality.

A liquid crystal display panel according to the present invention is a liquid crystal display panel for an In-Plane Switching mode liquid crystal display device. The liquid crystal display panel comprises: first and second substrates arranged so as to be opposed; a liquid crystal layer filled between the first and second substrates; a pixel circuit provided on a surface, of the first substrate, at a side of the liquid crystal layer, for applying a voltage to the liquid crystal layer; a black matrix provided on a surface, of the second substrate, at a side of the liquid crystal layer, made of a laminated film for which a metal oxide film and a metal film have been alternately laminated in two layers or more; a color filter provided on a surface, of the second substrate, at a side of the liquid crystal layer; an overcoat layer provided in a manner covering the black matrix and color filter; and a granular or columnar spacer provided on the overcoat layer on the black matrix, for holding a fixed gap between the first and second substrates. The black matrix has a thickness of 0.2 μm or less and an optical density (OD value) of 3 or more.

In the present invention, since the black matrix is formed of a laminated film for which a metal oxide film and a metal film have been alternately laminated in two layers or more, the thickness of the same has been provided as 0.2 μm or less, and the OD value, 3 or more, a high light-shielding effect can be obtained at a thinner film thickness than that of a black matrix formed of a pigment-dispersing resin. As a result, virtually no step is formed on the surface of the overcoat layer, and a decline in display quality resulting from this step can be suppressed.

For the black matrix, it is preferable that the metal oxide film has been arranged at a side furthest from the liquid crystal layer, and it is more preferable that the metal oxide film has also been arranged at a side closest to the liquid crystal layer. Thereby, light-shielding effect can be improved. Here, the metal oxide film layer is, for example, a chromium oxide film, and the metal film is, for example, a chromium film. Thereby, a reflected light in a visible wavelength region can be made inconspicuous. In addition, as the fixing-type spacer, a columnar spacer formed of a photosensitive resin can be provided.

An electric-field shielding layer may be formed, via an insulating film, on a part of the pixel circuit, said part being at least a part of an area opposed to the black matrix. Thereby, since an electric-field leakage generated by the pixel circuit and black matrix can be reduced, display quality can be improved.

It may be possible that a common electrode has been provided in the pixel circuit, and the electric-field shielding layer has been connected to the common electrode or a ground. In addition, it is possible that a data line and a scanning line extending in mutually orthogonal directions have been provided in the pixel circuit, and the electric-field shielding layer has been formed in a manner covering at least either the data line or scanning line. Thereby, an electric-field leakage generated by the pixel circuit and black matrix can be considerably reduced. Moreover, it may be possible that a thin-film transistor has been formed in the pixel circuit, and on the thin-film transistor, the electric-field shielding layer has not been formed. Thereby, without lowering thin-film transistor characteristics, an electric-field leakage generated by the pixel circuit and black matrix can be reduced.

It is also possible that an impurity is doped in the liquid crystal layer so that resistance becomes 1×10¹¹ through 1×10¹³Ω·cm. Thereby, the liquid crystal layer is hardly influenced by an electric-field leakage generated by the pixel circuit and black matrix. In addition, it is preferable that the black matrix has an OD value of 4 or more. Thereby, a high light-shielding effect can be obtained at a thin thickness.

A liquid crystal display device according to the present invention comprises the above-mentioned liquid crystal display panel. In the present invention, since a black matrix of the display panel has been formed of a metal thin film having a thickness of 0.2 μm or less, the film thickness can be made thinner than that of a black matrix made of a pigment-dispersing resin. As a result, virtually no step is formed on the surface of the overcoat layer, and an excellent display quality can be obtained.

According to the present invention, since a high light-shielding effect can be obtained at a thinner film thickness than that of a black matrix made of a pigment-dispersing resin by forming a black matrix of a laminated film for which a metal oxide film and a metal film have been alternately laminated in two layers or more, no step is formed on the surface of the overcoat layer, and display quality is improved.

### BRIEF DESCRIPTION OF THE DRAWINGS

FIG. 1 is a sectional view of a display panel of a conventional IPS-mode liquid crystal display device in a direction orthogonal to a direction in which a data line extends, including a spacer;

FIG. 2A and FIG. 2B are sectional views schematically showing a display panel of a liquid crystal display device of a first embodiment of the present invention;

FIG. 3A is a plan view showing a part of a color-filter substrate of the display panel shown in FIG. 2; FIG. 3B is a plan view showing a TFT substrate of the display panel shown in FIG. 2;

FIG. 4 is a sectional view schematically showing a display panel of a liquid crystal display device of a first modification of the first embodiment of the present invention;

FIG. 5 is a plan view showing a TFT substrate of the display panel shown in FIG. 4;

FIG. 6 is a plan view showing a TFT substrate of a display panel in a liquid crystal display device of a second modification of the first embodiment of the present invention;

FIG. 7 is a plan view showing a TFT substrate of a display panel in a liquid crystal display device of a third modification of the first embodiment of the present invention.

### DETAILED DESCRIPTION OF THE PREFERRED EMBODIMENTS

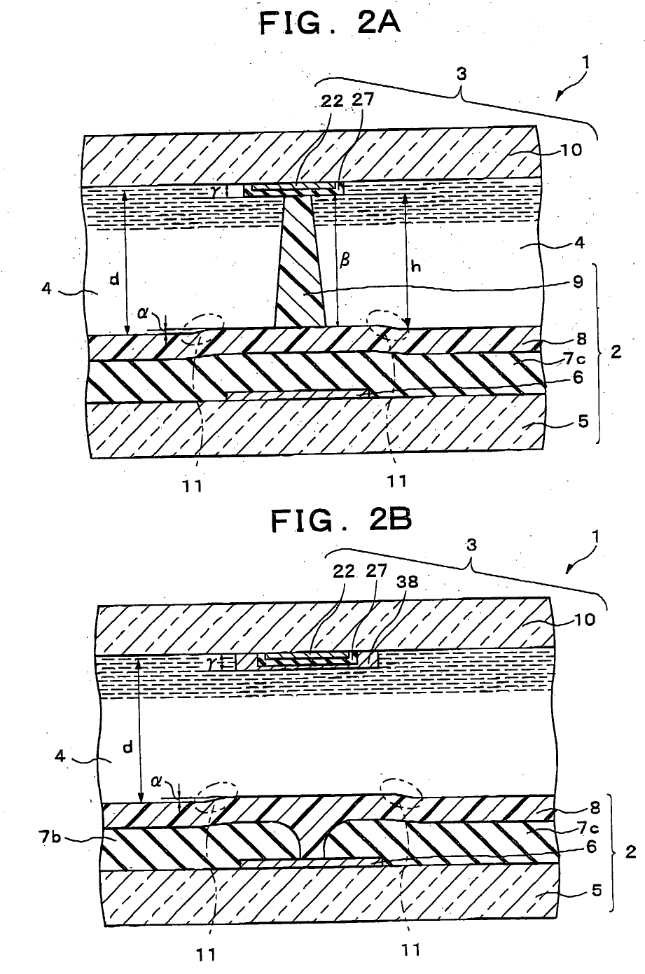

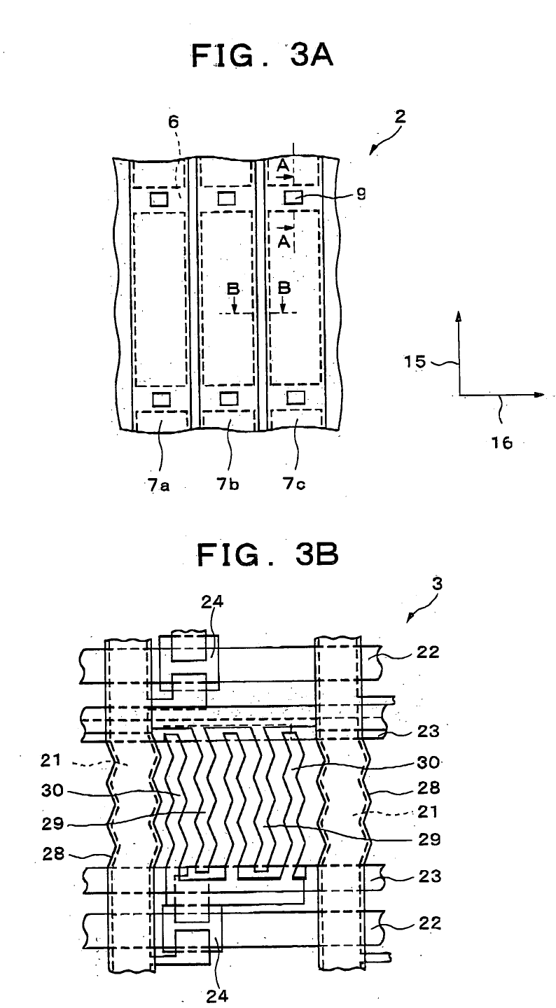

Hereinafter, liquid crystal display devices according to embodiments of the present invention will be described. First, description will be given of a liquid crystal display device according to a first embodiment of the present invention. FIG. 2A and FIG. 2B are sectional views schematically showing a display panel of the liquid crystal display device of the present embodiment, FIG. 3A is a plan view showing a part of a color-filter substrate of the display panel shown in FIG. 2, and FIG. 3B is a plan view showing a part of a TFT substrate of the display panel shown in FIG. 2. Here, FIG. 2A is equivalent to a section along a line A-A shown in FIG. 3A, while FIG. 2B is equivalent to a sectional view along a line B-B shown in FIG. 3A. Also, in FIG. 2A and FIG. 2B, for ease in viewing the drawings, components of the TFT substrate shown in FIG. 3B have been partially omitted. For the liquid crystal display device of the present embodiment, a light source (unillustrated), a liquid crystal panel, and a frame body (unillustrated) for storing and supporting these have been provided. Then, as shown in FIG. 2, in a display panel 1, a color-filter substrate 2 and a TFT substrate 3 have been provided parallel to each other. In addition, a liquid crystal layer 4 has been filled between the color-filter substrate 2 and TFT substrate 3.

As shown in FIG. 2 and FIG. 3, the color-filter substrate 2 has a transparent substrate 5 made of, for example, glass. A black matrix 6 made of metal materials such as chromium and titanium has been formed on the surface of the transparent substrate 5, at a side opposed to the TFT substrate 3. This black matrix 6 has been composed of a laminated film for which a metal oxide film and a metal film have been alternately laminated in two layers or more, and a thickness of the black matrix 6 is 0.2 μm or less. Here, it is sufficient that the black matrix 6 has a minimum thickness to obtain a desirable light-shielding effect, and although not particularly limited, the lower-limit value is on the order of 0.02 μm, for example. The laminated film has preferably a metal oxide film on the transparent substrate 5 and a metal film formed on the metal oxide film, the metal film being higher in the light-shielding effect than the metal oxide film. In addition, it is more desirable to provide a film closest to the liquid crystal layer 4 side as a metal oxide film. Thereby, a high light-shielding effect can be obtained at a thin film thickness. An OD (Optical Density) value of this black matrix 6 is 3 or more, and is more preferably 4 or more. Here, the higher the OD value of a black matrix, the more it is preferable, however, the upper limit of the OD value is on the order of 5 when currently available light-shielding thin-film materials are used. As the metal materials for forming such a black matrix 6, materials which have a light-shielding effect and which are capable of forming a thin film on the transparent substrate 5 made of glass or a resin are sufficient, however, it is preferable that these are chromium and chromium oxide for which the peak of a reflected light in a visible wavelength region exists at the blue side and the reflected light is inconspicuous when being visually observed.

In addition, color layers 7a through 7c composing a color filter are formed on the surface of the transparent substrate 5, the surface being at the side opposed to the TFT substrate 3. The color layers 7a through 7c are provided in a horizontal direction 16 so as to sandwich the black matrix 6 between each of the color layers 7a through 7c. Of these, the color filter 7a is, for example, red (R), the color layer 7b is, for example, green (G), and the color layer 7c is, for example, blue (B). Then, end portions in the horizontal direction 16 of the color layers 7a through 7c have been formed so as to run onto end portions in the horizontal direction 16 of the black matrix 6, while in a vertical direction 15, the color layers 7a through 7c have been formed on the black matrix 6, as well.

Furthermore, an overcoat layer 8 has been formed in a manner covering the black matrix 6 and color layers 7a through 7c, and a columnar spacer 9 made of an acrylic or epoxy-based photosensitive resin has been formed on the overcoat layer 8 formed above the black matrix 6. This columnar spacer 9 has been formed in a region opposed, when the color-filter substrate 2 is opposed to the TFT substrate 3, to a region where a gate electrode 22 as a scanning line has been formed and no data line 21 or TFT 24 has been formed in the TFT substrate 3. Still furthermore, in this display panel 1, an alignment film (unillustrated) which has received an alignment treatment in a fixed direction has been formed on the overcoat layer 8 and columnar spacer 9.

On the other hand, in the TFT substrate 3, a transparent substrate 10 made of, for example, glass has been provided, and on the surface, of the transparent substrate 10, at a side opposed to the color-filter substrate 2, a gate electrode 22 and common electrode wiring 23 have been formed parallel to each other, and on these, an interlayer insulating film (unillustrated) has been formed. In addition, on this interlayer insulating film, a data line 21 extending in a direction orthogonal to the gate electrode 22 has been formed. In addition, a TFT 24 has been formed in the vicinity of a position where the data line 21 intersects with the gate electrode 22. Furthermore, an insulating film 27 has been formed in a manner covering the data line 21 and TFT 24, and on the insulating film 27 formed on the data line 21, an electric-field shielding layer 28 has been formed in a manner covering the data line 21. This electric-field shielding layer 28 is made of a transparent conductive film such as an ITO film, and a thickness of the same is 0.04 μm, for example. Still furthermore, on the interlayer insulating film, a common electrode 29 and a pixel electrode 30 made of a transparent conductive film such as an ITO film have been formed parallel to each other, and the electric-field shielding layer 28 is connected to the common electrode 29 or a ground. Here, on the surface of the TFT substrate 3, a step caused by wirings such as a data line 21 and a gate electrode 22 has been formed, and this step has a height γ of, for example, 0.2 through 0.5 μm.

In the liquid crystal display device of the present embodiment, since the black matrix 6 has been formed of a laminated film composed of a metal oxide film and a metal film, the OD value can be made 3 or more at a film thickness thinner than that of a conventional black matrix formed of a pigment-containing resin. Then, for example, when a chromium oxide film and a chromium film are laminated on the transparent substrate 5 in this order to form a black matrix 6 having a thickness of approximately 0.17 μm and thereon color layers 7a through 7c having a thickness of approximately 1.9 μm and an overcoat layer 8 having a thickness of approximately 1.0 μm have been formed, a height a of a step 11 to be formed on the surface of the overcoat layer 8 results in 0.09 μm. As such, for the display panel 1 of the liquid crystal display device of the present embodiment, since the surface of the overcoat layer 8 is almost flat, uniformity in an alignment treatment of an alignment film to be formed on the overcoat layer 8 is improved in comparison with the conventional liquid crystal display device. As a result, a light leakage in a black display and an uneven display in a halftone are reduced, thus display quality such as contrast and display uniformity is improved.

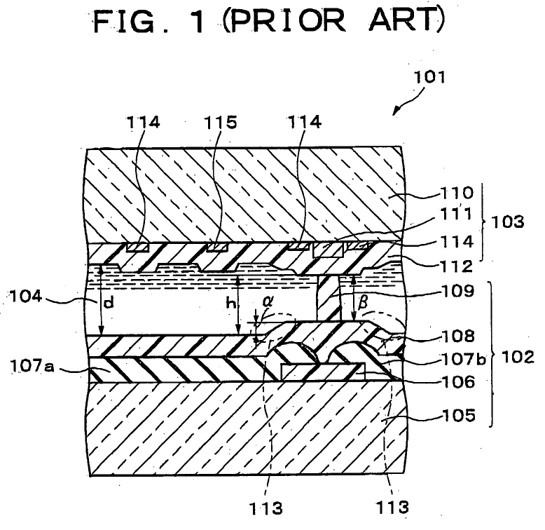

In addition, the columnar spacer 9 is arranged in a region directly above the black matrix 6, that is, a part where the surface of the overcoat layer 8 has risen in a reflection of the shape of the black matrix 6, and in a region directly below the gate electrode 22, that is, a part where the surface of the insulating film 27 has risen in a reflection of the shape of the gate electrode 22. Therefore, a cell gap d results in a sum of the height γ of the step caused by the gate electrode 22 formed on the surface of the TFT substrate 3 and a column height h. Namely, a cell gap d of the display panel 1 results in a sum of the height α of the step 11 caused by the black matrix formed on the surface of the overcoat layer 8, a height β of the columnar spacer 9, and the height γ of the step formed on the surface of the TFT substrate 3(d=α+β+γ). Accordingly, when the cell gap d has an identical value, the height β of the columnar spacer 9 can be heightened by reducing the height α of the step 11 formed on the surface of the overcoat layer 8. Concretely, when the column height h is provided as 3 μm similar to that of the conventional liquid crystal display device shown in FIG. 1, the height β of the columnar spacer 9 results in 2.91 μm, which can be made higher by not less than 0.5 μm than that of the conventional liquid crystal display device shown in FIG. 1. Thereby, the elastic deformation volume of the columnar spacer 9 is increased, resilience to a local pressurization from outside is improved, thus a display defect caused by a local unevenness in the gap hardly occurs.

Furthermore, with a small elastic deformation volume of the spacer, when the liquid crystal layer expands owing to a rise in temperature of the display panel, the spacer cannot follow this expansion and comes off from the TFT substrate, and the cell gap within a screen becomes non-uniform in some cases. However, in the liquid crystal display device of the present embodiment, since the height of the columnar spacer 9 can be made higher than the conventional one, the elastic deformation volume is increased, therefore, even when the liquid crystal layer 4 expands, the columnar spacer 9 follows the same, and the cell gap d within a screen can be uniformly held. As a result, display uniformity is improved.

Still furthermore, since the black matrix 6 made of metal materials is higher in adhesion with the transparent substrate 5 made of glass or the like than a black matrix made of a pigment-dispersing resin, it is possible to form thereon a sealing pattern. Thereby, the display panel can be provided with a narrower frame than that of the conventional liquid crystal display device, and manufacturing efficiency is improved.

Still furthermore, for a black matrix made of a pigment-dispersing resin, resistance easily varies depending on a pigment dispersing condition and a resin coating condition when being formed, and resistance is easily changed by heat deterioration owing to heating after formation, however, the black matrix 6 made of metal materials as in the liquid crystal display device of the present embodiment is not influenced by the materials or the step after formation, and resistance fluctuates little. Therefore, a wider manufacturing margin can be provided than that when a black matrix is formed of a pigment-dispersing resin, thus a display panel excellent in uniformity without an uneven display can be stably manufactured. Still furthermore, since a black matrix made of metal materials is higher in patterning accuracy than a black matrix made of a pigment-dispersing resin, the liquid crystal display device of the present embodiment can be provided with a higher definition than that of the conventional liquid crystal display device.

However, when the black matrix 6 made of metal materials is applied to an IPS-mode liquid crystal display device, a display defect occurs owing to an unnecessary electric field from the TFT substrate 3 in some cases. As a method for preventing an influence of this electric field leakage from the TFT substrate 3, although a method for applying a potential to the black matrix 6 from outside has been proposed (Patent No. WO1997/10530 and U.S. Pat. No. 3,484,702), this method is unpractical since the structure of the display panel is complicated. Accordingly, in the liquid crystal display device of the present embodiment, by covering the data line 21 formed in a region opposed to the black matrix 6 with the electric-field shielding layer 28 via the insulating film 27, an unnecessary electric field leakage from the data line 21 is shielded. As a result, even when the black matrix 6 is formed of metal films, occurrence of a display defect can be avoided without applying a potential from outside.

Furthermore, in the liquid crystal display device of the present embodiment, an impurity may be doped in the liquid crystal layer 4 so that resistance of the liquid crystal layer 4 becomes 1×10¹¹ through 1×10¹³Ω·cm. Thereby, it becomes possible to make the liquid crystal layer 4 be hardly influenced by an electric field leakage generated by the pixel circuit and black matrix, and occurrence of after-image and burn-in and occurrence of a display defect such as a decline in flicker characteristics can be suppressed.

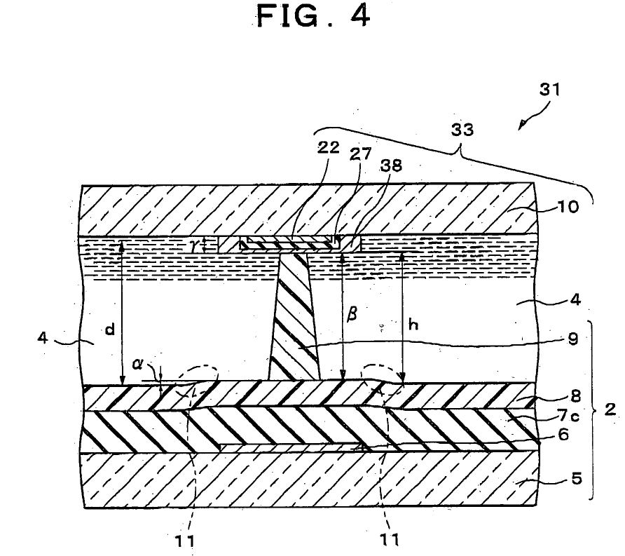

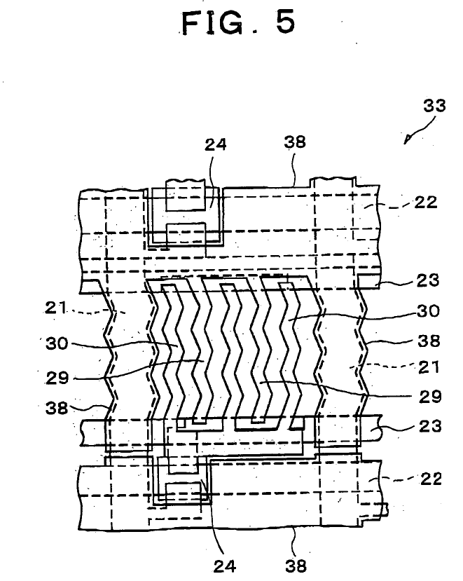

Next, description will be given of a liquid crystal display device of a first modification of the first embodiment of the present invention. FIG. 4 is a sectional view schematically showing a display panel of a liquid crystal display device of a first modification of the present embodiment, and FIG. 5 is a plan view showing a TFT substrate of the same. Here, in FIG. 4 and FIG. 5, identical symbols are used for components the same as those of the display panel 1 shown in FIG. 2 and FIG. 3, and detailed description thereof is omitted. Moreover, in a display panel 31 shown in FIG. 4, the color-filter substrate 2 shown in FIG. 3A is used, and FIG. 4 is equivalent to a section along a line A-A shown in FIG. 3A. In the liquid crystal display device of the above-mentioned first embodiment, by forming the electric-field shielding layer 28 in a manner covering the data line 21, electric fields generated by the data line 21 and black matrix 6 have been shielded, however, the present invention is not limited hereto, and it is satisfactory that an electric-field shielding layer is provided in a manner covering at least a part of wiring portions such as a data line 21 and a gate electrode 22 formed at positions opposed to the black matrix 6.

Accordingly, as shown in FIG. 4 and FIG. 5, in the liquid crystal display device of the present modification, an electric-field shielding layer 38 is provided in a manner covering the data line 21 and gate electrode 22. Thereby, an unnecessary electric field leakage from a TFT substrate 33 is further reduced, and a light leakage is suppressed while display quality such as contrast and display uniformity is improved.

In addition, similar to the liquid crystal display device of the above-mentioned first embodiment, in the liquid crystal display device of the present modification as well, the columnar spacer 9 is arranged in a region directly above the black matrix 6 and in a region directly below the gate electrode 22, and a cell gap d of the display panel 31 results in a sum of a height γ of a step formed on the surface of the TFT substrate 33 and a column height h. In the liquid crystal display device of the present modification, the height γ of a step on the surface of the TFT substrate 33 is increased by a height equal to a thickness of the electric-field shielding layer 38, this height γ of a step can be equalized to the height γ of the step on the surface of the TFT substrate 3 of the display panel 1 shown in FIG. 2 by adjusting the thickness of the gate electrode 22 and insulating film 27. Therefore, the cell gap d of the display panel 31 can also be equalized to the cell gap d of the display panel 1 shown in FIG. 2, and even when the cell gap d has been determined in advance, a height β of the columnar spacer 9 can be made higher than that of the conventional liquid crystal display device. Here, aspects of the construction and effects of the liquid crystal display device of the present modification other than the above are the same as those of the crystal display device of the above-mentioned first embodiment.

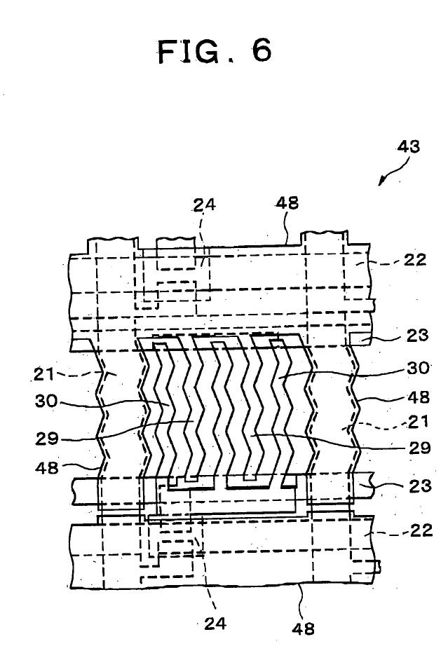

Next, description will be given of a liquid crystal display device of a second modification of the first embodiment of the present invention. FIG. 6 is a plan view showing a TFT substrate of a display panel of a liquid crystal display device of the present modification. Here, in FIG. 6, identical symbols are used for components the same as those of the TFT substrate 3 shown in FIG. 3B, and detailed description thereof is omitted. As shown in FIG. 6, in the liquid crystal display device of the present modification, in a manner covering, in addition to the data line 21 and gate electrode 22, the TFT 24, an electric-field shielding layer 48 is provided. Thereby, an unnecessary electric field leakage from a TFT substrate 43 can be reduced further than that in the liquid crystal display device of the above-mentioned first modification. However, when an electric-field shielding layer 48 is formed on the TFT 24, since characteristics of the TFT 24 are lowered in some cases, if an influence on the TFT 24 is great, the construction of the above-mentioned first modification is preferably employed. Here, aspects of the construction and effects of the liquid crystal display device of the present modification other than the above are the same as those of the crystal display device of the above-mentioned first embodiment.

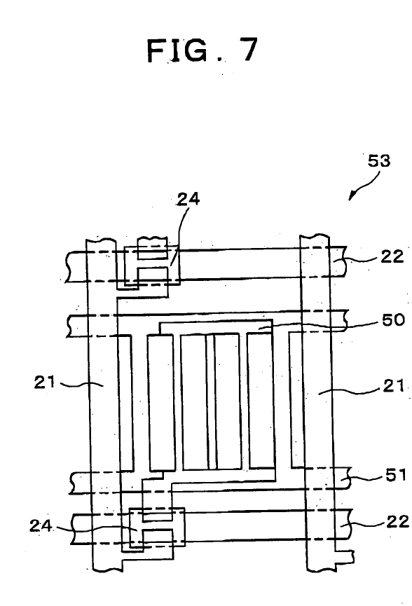

Next, description will be given of a liquid crystal display device of a third modification of the first embodiment of the present invention. FIG. 7 is a plan view showing a TFT substrate of a display panel of a liquid crystal display device of the present modification. Here, in FIG. 7, identical symbols are used for components the same as those of the TFT substrate 3 shown in FIG. 3B, and detailed description thereof is omitted. In the liquid crystal display device of the above-mentioned first embodiment and liquid crystal display devices of the first and second modifications of the same, the comb teeth-like common electrode 29 and pixel electrode 30 have been formed on the TFT substrate, however, the present invention is not limited hereto, and as shown in FIG. 7, a conventional TFT substrate 53 on which a common electrode 51 and a pixel electrode 50 have been formed via an interlayer insulating film (unillustrated) can also be used.

Since no shielding layer has been provided on this conventional TFT substrate 53, display quality such as contrast and display uniformity is low in comparison with that of the liquid crystal display device of the above-mentioned first embodiment and liquid crystal display devices of the first and second modifications of the same, and moreover, a light leakage may occur, however, the surface of the color-filter substrate 2 is almost flat, an unevenness in the gap hardly occurs even when a local pressurization is given.

Here, in the liquid crystal display devices of the above-mentioned first embodiment and the first through third modifications of the same, the columnar spacers 9 have been formed on the color-filter substrate 2, however, the present invention is not limited hereto, and it is satisfactory the spacers are fixing-type spacers that can be fixed to a predetermined position, preferably, above the black matrix 6, and for example, spacers such as granular spacers and spacers provided in desirable forms by patterning a film made of an organic material can also be used. Here, as in the liquid crystal display device of the present embodiment, it is more preferable to use columnar spacers formed by use of a photosensitive resin.

Hereinafter, effects of examples of the present invention will be described in comparison with comparative examples that deviate from the scope of the present invention. First, as embodiments of the present invention, display panels of Examples 1 through 5 having structures as shown in FIG. 2 and FIG. 3 have been fabricated, with a column height h of 3.0 μm, while adjusting the amount of liquid crystal to be filled in the display panels by pressurizing conditions at the time of filling. In addition, as comparative examples of the present invention, display panels of Comparative examples 1 through 5 having a structure shown in FIG. 1 have been fabricated on the same conditions. Then, in regard to these display panels of Examples 1 through 5 and Comparative examples 1 through 5, temperature dependence of display uniformity has been evaluated in a range of 10 through 70° C. In such a case, the smaller the amount of pressurization at the time of liquid crystal filling, the greater the amount of liquid crystal in the display panel becomes, and when the liquid crystal expands owing to a rise in surface temperature of the display panel, occurrence of a display defect (lower-side yellow unevenness) caused by the cell gap d increases. Therefore, in the present embodiments, display condition of each display panel was visually checked, and a case with no lower-side yellow unevenness was shown by ⊚, a case of a slight recognition at a gradation level 0 was shown by ∘, a case of recognition at a gradation level 0 and a slight recognition at a halftone and absolute white was shown by Δ, a case of recognition irrespective of gradation level was shown by ×, and a case of clear recognition was shown by ××. The results of observation are shown in the following Table 1. Here, pressurizing conditions shown in the following Table 1 are values standardized based on a center value of 1.

TABLE 1

| | Pressure | Display panel surface temperature(° C.) | | | | | | |
|---|---|---|---|---|---|---|---|---|
| | condition | 10 | 20 | 30 | 40 | 55 | 60 | 70 |
| Example 1 | 0.43 | ⊚ | ⊚ | ⊚ | ⊚ | ◯ | ◯ | X |
| Example 2 | 0.65 | ⊚ | ⊚ | ⊚ | ⊚ | ⊚ | ⊚ | Δ |
| Example 3 | 1.00 | ⊚ | ⊚ | ⊚ | ⊚ | ⊚ | ⊚ | ◯ |
| Example 4 | 1.30 | ⊚ | ⊚ | ⊚ | ⊚ | ⊚ | ⊚ | ⊚ |
| Example 5 | 1.52 | ⊚ | ⊚ | ⊚ | ⊚ | ⊚ | ⊚ | ⊚ |
| Comparative | 0.43 | ⊚ | ⊚ | ⊚ | ⊚ | X | X | XX |
| example 1 | | | | | | | | |
| Comparative | 0.65 | ⊚ | ⊚ | ⊚ | ⊚ | ⊚ | X | X |
| example 2 | | | | | | | | |
| Comparative | 1.00 | ⊚ | ⊚ | ⊚ | ⊚ | ⊚ | ⊚ | ◯ |
| example 3 | | | | | | | | |
| Comparative | 1.30 | ⊚ | ⊚ | ⊚ | ⊚ | ⊚ | ⊚ | ⊚ |
| example 4 | | | | | | | | |
| Comparative | 1.52 | ⊚ | ⊚ | ⊚ | ⊚ | ⊚ | ⊚ | ⊚ |
| example 5 | | | | | | | | |

As shown in the above Table 1, in the cases of display panels of Comparative examples where the black matrixes had been formed of pigment-containing resins, the display panels of Comparative examples 3 through 5 where the pressurizing conditions were 1.00 or more had virtually no occurrence of lower-side yellow unevenness in the entire range of 10 through 70° C., whereas in Comparative example 1 where the pressurizing condition was less than 1.00, a lower-side yellow unevenness occurred at 55° C. or more, and in the display panel of Comparative example 2, at 60° C. or more, thus display quality had considerably deteriorated.

On the other hand, in the cases of display panels of Examples where the black matrixes had been formed of laminated films of chromium oxide film and chromium film, the display panels of Example 3 through 5 where the pressurizing conditions were 1.00 or more had virtually no occurrence of lower-side yellow unevenness in the entire range of 10 through 70° C. In addition, the display panels of Example 1 and Example 2 where the pressurizing conditions were less than 1.00 had deteriorated in display quality at 70° C., but had virtually no occurrence of lower-side yellow unevenness until 60° C., thus the display panels have been improved in display quality in comparison with those of Comparative examples 1 and 2.

What is claimed is:

1. A liquid crystal display panel comprising:
first and second substrates arranged so as to be opposed;
a liquid crystal layer filled between the first and second substrates;
a pixel circuit provided on a surface, of the first substrate, at a side of the liquid crystal layer, for applying a voltage to the liquid crystal layer;
a black matrix provided on a surface, of the second substrate, at a side of the liquid crystal layer, made of a laminated film for which a metal oxide film and a metal film have been alternately laminated in two layers or more, having a thickness of 0.2 μm or less and an optical density (OD value) of 3 or more;
a color filter provided on a surface, of the second substrate, at a side of the liquid crystal layer;
an overcoat layer provided in a manner covering the black matrix and color filter; and
a granular or columnar spacer provided on the overcoat layer on the black matrix, for holding a fixed gap between the first and second substrates,
wherein said liquid crystal display panel is mounted on an In-Plane Switching mode liquid crystal display device.

2. The liquid crystal display panel as set forth in claim 1, wherein
for the black matrix, the metal oxide film has been arranged at a side furthest from the liquid crystal layer.

3. The liquid crystal display panel as set forth in claim 2, wherein
for the black matrix, the metal oxide film has been arranged at a side closest to the liquid crystal layer.

4. The liquid crystal display panel as set forth in claim 1, wherein
the metal oxide film is a chromium oxide film, and the metal film is a chromium film.

5. The liquid crystal display panel as set forth in claim 1, wherein
the fixing-type spacer is a columnar spacer formed of a photosensitive resin.

6. The liquid crystal display panel as set forth in claim 1, further comprising
an electric-field shielding layer formed, via an insulating film, on a part of the pixel circuit, said part being at least a part of an area opposed to the black matrix.

7. The liquid crystal display panel as set forth in claim 6, wherein
said pixel circuit has a data line and a scanning line extending in mutually orthogonal directions, and the electric-field shielding layer has been formed in a manner covering at least either the data line or the scanning line.

8. The liquid crystal display panel as set forth in claim 6, wherein
said pixel circuit has a common electrode, and the electric-field shielding layer has been connected to the common electrode or a ground.

9. The liquid crystal display panel as set forth in claim 7, wherein
said pixel circuit has a data line and a scanning line extending in mutually orthogonal directions, and the electric-field shielding layer has been formed in a manner covering at least either the data line or scanning line.

10. The liquid crystal display panel as set forth in claim 6, wherein
said pixel circuit has a thin-film transistor, and the electric-field shielding layer has not been formed on the thin-film transistor.

11. The liquid crystal display panel as set forth in claim 7, wherein
said pixel circuit has a thin-film transistor, and the electric-field shielding layer has not been formed on the thin-film transistor.

12. The liquid crystal display panel as set forth in claim 8, wherein
said pixel circuit has a thin-film transistor, and the electric-field shielding layer has not been formed on the thin-film transistor.

13. The liquid crystal display panel as set forth in claim 9, wherein
said pixel circuit has a thin-film transistor, and the electric-field shielding layer has not been formed on the thin-film transistor.

14. The liquid crystal display panel as set forth in claim 7, wherein
in the liquid crystal layer, an impurity is doped so that resistance becomes 1×10¹¹ through 1×10¹³Ω·cm.

15. The liquid crystal display panel as set forth in claim 1, wherein
the black matrix has an optical density of 4 or more.

16. A liquid crystal display device comprising the liquid crystal display panel as set forth in claim 1.
